(19) United States
(12) Patent Application Publication
(10) Pub. No.: US 2019/0385223 A1
(43) Pub. Date: Dec. 19, 2019

(54) Blockchain Banking Gateway

(71) Applicant: Amit Sharma, Springfield, MA (US)

(72) Inventor: Amit Sharma, Springfield, MA (US)

(21) Appl. No.: 16/212,020

(22) Filed: Dec. 6, 2018

Related U.S. Application Data
(60) Provisional application No. 62/595,475, filed on Dec. 6, 2017.
(60) Provisional application No. 62/595,548, filed on Dec. 6, 2017.
(60) Provisional application No. 62/697,753, filed on Jul. 13, 2018.
(60) Provisional application No. 62/697,849, filed on Jul. 13, 2018.
(60) Provisional application No. 62/697,859, filed on Jul. 13, 2018.
(60) Provisional application No. 62/697,870, filed on Jul. 13, 2018.

(51) Int. Cl. G06Q 40/02; H04L 9/08; G06Q 20/10

(52) U.S. Cl. CPC G06Q 40/02; G06Q 20/108; H04L 9/088

(57) ABSTRACT

Integration of traditional core banking with blockchain functionality. The disclosed ensures adherence to global risk and compliance standards. Further, the disclosed systems and methods facilitate a safe, secure, and transparent gateway for driving financial inclusion for entities and individuals alike.

### PRIORITY

This application claims the benefit of U.S. Provisional 62/595,475, filed Dec. 6, 2017, U.S. Provisional 62/595,548, filed Dec. 6, 2017, U.S. Provisional 62/697,753, filed Jul. 13, 2018, U.S. Provisional 62/697,849, filed Jul. 13, 2018, U.S. Provisional 62/697,859, filed Jul. 13, 2018, and U.S. Provisional 62/697,870, filed Jul. 13, 2018, the disclosures of which are hereby incorporated by reference as if submitted in their entireties.

### FIELD OF THE INVENTION

The present invention relates to technology-enabled, compliance-centric financial management, and, more particularly, mobile and web-based traditional and digital banking via a single gateway utilizing blockchain functionality.

### BACKGROUND

The underserved and excluded market goes beyond the un-/underbanked. FinTechs and non-bank financial institutions (NBFIs) are generally excluded by traditional banks due to perceived Anti-Money Laundering (AML) and other compliance concerns. This misunderstanding and fear of core business and regulatory “labeling” categorizes them as a high compliance risk.

### BRIEF SUMMARY OF THE INVENTION

Systems and methods are provided for the integration of traditional core banking with blockchain functionality. The disclosed ensures adherence to global risk and compliance standards. Further, the disclosed systems and methods facilitate a safe, secure, and transparent gateway for driving financial inclusion for entities and individuals alike.

Systems and methods provided herein include core bank processing connections integrated into the platform with initial banks of record, mobile and web-based applications for onboarding and account access to provide basic banking and support (i.e. business and retail support), traditional and digital banking products via a single gateway, and a blockchain anchor on a dedicated network.

Systems and methods provided herein implements a platform that consolidates banking-as-a-service. The platform facilitates fiat and digital currency transactions, integrates blockchain technology with core banking, provides AML, and KYC compliance capabilities in accordance with global standards across both bank-related and blockchain-enabled transactions and payments, incorporates global standard compliance protocols to drive onboarding and engagement across traditional and blockchain-enabled financial services, enables correspondent banking relations via an anchor node, and integrates with community-based financial institutions.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

The detailed description makes reference to the accompanying figures in which:

FIG. 1 a simplified functional block diagram of a computer system 100;

FIG. 2 is simplified example of a distributed ledger in accordance with at least one embodiment of the invention.;

FIG. 3 is a block diagram depicting an example blockchain environment 300, illustrating a simplified example of how a distributed ledger, or blockchain may be distributed, or replicated, on a network; and

FIG. 4 illustrates an exemplary gateway and banking solution architecture diagram in accordance with the disclosed invention;

FIG. 5 illustrates an exemplary architecture of partner/client connectivity;

FIG. 6 illustrates a blockchain enabled digital banking solution architecture in accordance with one or more embodiments of the disclosed invention;

FIGS. 7A-7F illustrates exemplary screenshots of the disclosed invention;

FIG. 8 illustrates an exemplary environment diagram of a node gateway engine;

FIG. 9 illustrates an exemplary operating architecture overview utilizing API integration in accordance with the disclosed invention; and

FIG. 10 illustrates an exemplary diagram for facilitating blockchain transactions in a banking as a service platform.

### DETAILED DESCRIPTION

The figures and descriptions provided herein may have been simplified to illustrate aspects that are relevant for a clear understanding of the herein described apparatuses, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, for the sake of brevity a discussion of such elements and operations may not be provided herein. However, the present disclosure is deemed to nevertheless include all such elements, variations, and modifications to the described aspects that would be known to those of ordinary skill in the art.

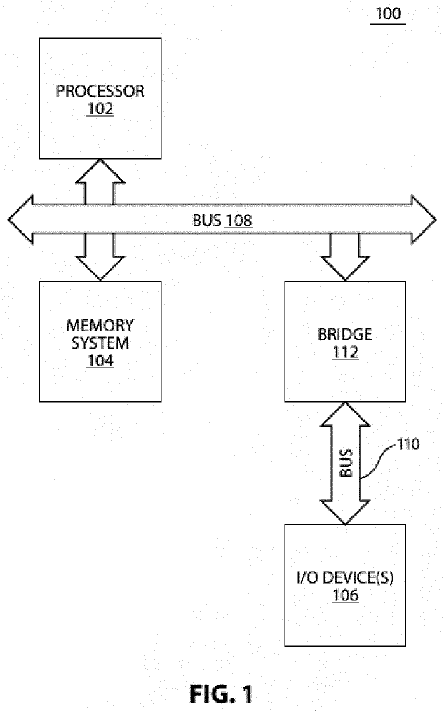

FIG. 1 is an example of a simplified functional block diagram of a computer system 100. The functional descriptions of the present invention can be implemented in hardware, software or some combination thereof.

As shown in FIG. 1, the computer system 100 includes a processor 102, a memory system 104 and one or more input/output (I/O) devices 106 in communication by a communication ‘fabric’. The communication fabric can be implemented in a variety of ways and may include one or more computer buses 108, 110 and/or bridge and/or router devices 112 as shown in FIG. 1. The I/O devices 106 can include network adapters and/or mass storage devices from which the computer system 100 can send and receive data for generating and transmitting advertisements with endorsements and associated news. The computer system 100 may be in communication with the Internet via the I/O devices 108.

Those of ordinary skill in the art will recognize that many modifications and variations of the present invention may be implemented without departing from the spirit or scope of the invention. Thus, it is intended that the present invention cover the modification and variations of this invention provided they come within the scope of the appended claims and their equivalents.

The various illustrative logics, logical blocks, modules, and engines, described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

In various embodiments, a blockchain, or distributed ledger, provides a decentralized approach to tracking information. By eliminating the need for a central authority, information and transactions therewith may be circulated and verified over a network. A blockchain may provide a secure solution for tracking, for example, the ownership and transfer of assets. In a simplified example, a blockchain may provide proof of who owns what at any given point in time and be replicated on hundreds or thousands of computing nodes.

Blockchain structure offers solutions to the dilemma of balancing data, identity, and transaction-based privacy and security. By way of example, security and privacy breaches have occurred, and may continue to happen, within large, often centrally organized entities, such as, for example, big box store retailers, social networks, closed networks, governments and militaries. For consumer facing entities, the privacy and security of customer information, payment information, and transaction histories may be paramount to the success of the business. For closed networks, governments and military networks, the security of data is often directly related to the safety and security of a group of people.

As described herein, blockchain and the related decentralized applications based on blockchain may provide solutions to data security, for example, when using cryptographically-secured encryption as a part of the blockchain used in the particular applications, especially as related to the data parts. Although current systems and networks encrypt data, the decentralizing of various aspects of an information architecture may allow for unintended breaches in currently employed encryption chains and layers as, for example, individual users manipulate and interact with their own data. Using blockchain to hold data, authentication information, and encryption aspects, user data and central repositories may be less vulnerable to data losses or breaches. For example, blockchains may store encrypted information and coded pointers to distributed storage locations that may be spread across distributed computer networks. Such a method may prevent those seeking to access or alter the information in an unauthorized manner from doing so by creating a highly distributed temporal infrastructure which may be impractical to reconstruct or, for example, impossible to reconstruct even if the unauthorized user is able to obtain a portion of the information associated with the blockchain.

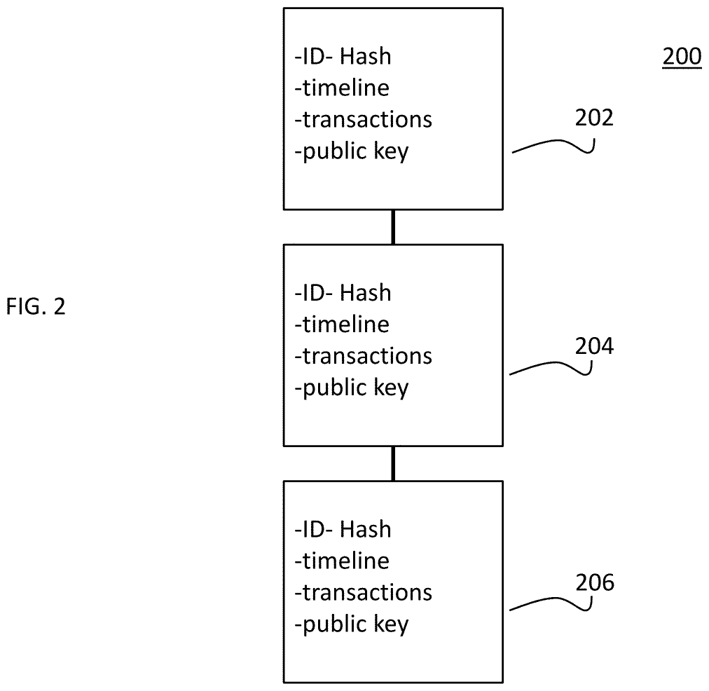

As illustrated in FIG. 2, blockchain 200 is an illustrative example in accordance with at least one embodiment of the invention. Blockchain 200 illustrates a simplified blockchain having 3 blocks, 202, 204, and 206. Block 202 is the first block and is therefore considered to be the genesis block. Each block may include certain information, such as an Identification, or hash, that uniquely identifies the block, a timeline identifying previous blocks (e.g., the hash numbers of previous blocks) in chronological order, transactions to record all transfers between a sender and a receiver, and a public key that identifies at least one sender and at least one receiver. Hash values may be combined into a Merkle tree. The linked blocks therefore form a chain where each link, or block, in the chain uniquely identifies a previous link, or block, by including the hash or the prior link, or block.

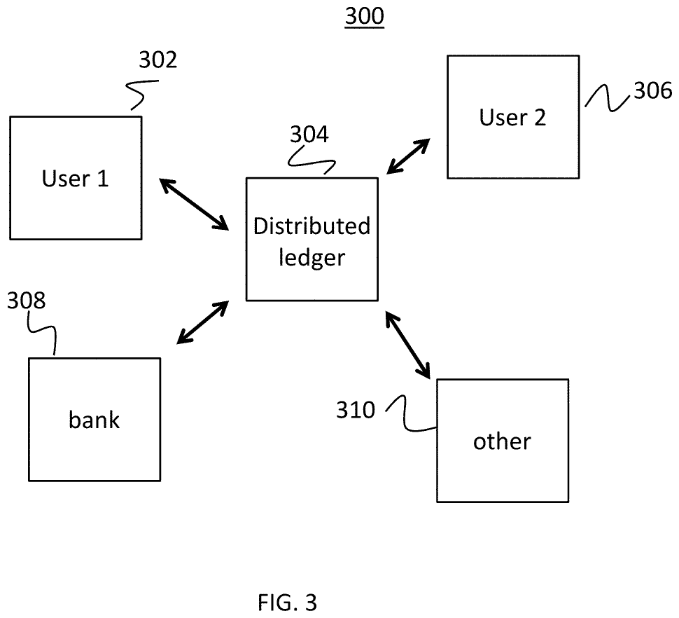

FIG. 3 is a block diagram depicting an example blockchain environment 300, illustrating a simplified example of how a distributed ledger, or blockchain (such as blockchain 200) may be distributed, or replicated, on a network. Environment 300 may include a first user 302, a second user 304, another entity, such as a bank 308, and another third party entity 310 privy to the blockchain 306. The first/second user may be a buyer or seller, based on the transaction. Entities may include, but are not limited to, consumers, bankers, merchants, and investors. Blockchain 306 may be replicated in an agreed-upon manner or in real-time (e.g., after each transaction).

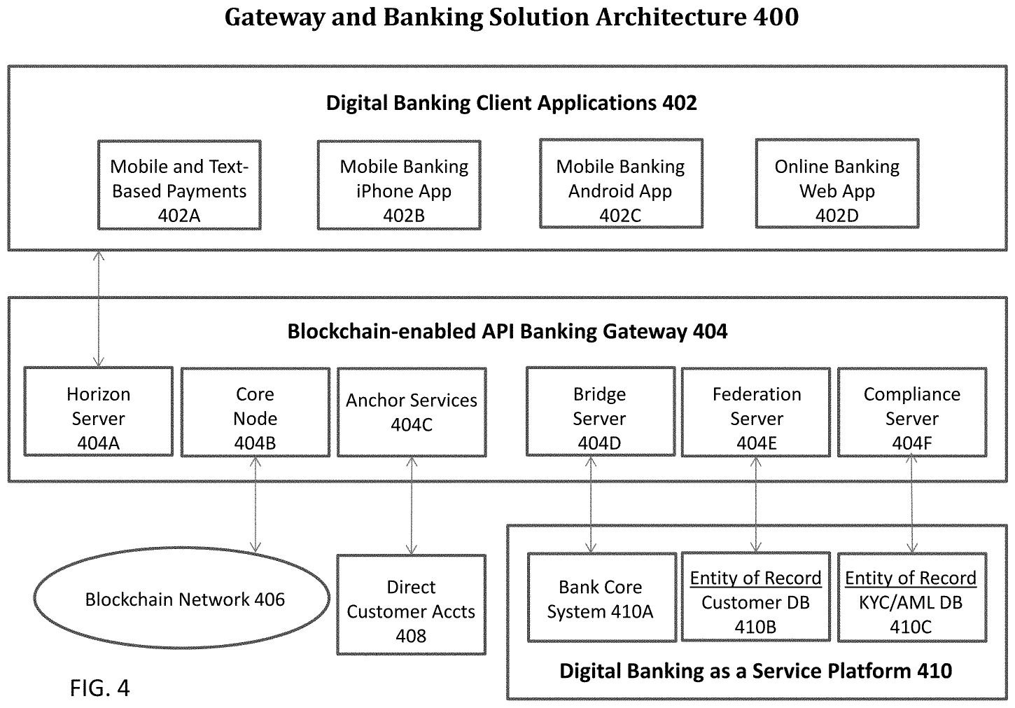

FIG. 4 illustrates a gateway and banking solution architecture in accordance with the disclosed embodiments. The architecture may include a plurality of elements/components/modules working concurrently and in conjunction. The architecture may include a series of digital banking client applications 402. Applications may include mobile and text-based payments 402A, mobile banking apps 402B and 402C (e.g., iOS or Android®), and an online mobile banking app 402D, for example. Applications 402 may be communicatively coupled to a blockchain enabled API banking gateway 404. Gateway 404 may include a series of servers. The servers may be a horizon server 404A, a core node 404B, anchor services 404C, a bridge server 404D, a federation server 404E, and a compliance server 404F, for example. The core node 404B may be communicatively coupled to an external network, such as a blockchain network 406. Anchor services may be communicatively coupled to external user data, such as direct customer accounts database 408. Gateway 404 may be communicatively coupled with an external platform, such as Digital Banking as a Service Platform 410. Platform 410 may include a Bank Core system 410A, an Entity of Record Customer database 410B, and an Entity of Record KYC/AML database 410C.

Gateway services may include, for example:

B2B: nonbank FIs, fintechs, business enterprise, correspondent banking

Regulated financial intermediation/processing to meet core operating needs

Blockchain for secured payments, AML/KYC, identity management

AI-based analytics for transactions monitoring, illicit finance controls and data driven business intelligence

Global standard AML/KYC framework, risk/compliance testing and training

B2C: (through targeted B2B clients)

FDIC insured accounts, with retail banking products and services

Secure digital access: P2P transfers (digital assets and fiat), direct deposit, NFC, RDC, remittances

Significant cost savings and value through automated account issuance and management

Enhanced risk/compliance and ID management processes & security via blockchain anchor and services

Single-point fin/reg-tech integration: simplifies data protocols, legal agreements

Proactive compliance & customer service/engagement—both traditional products and digital

Easy API plug-in, cloud based data management/storage, analytics, and fully digital UX

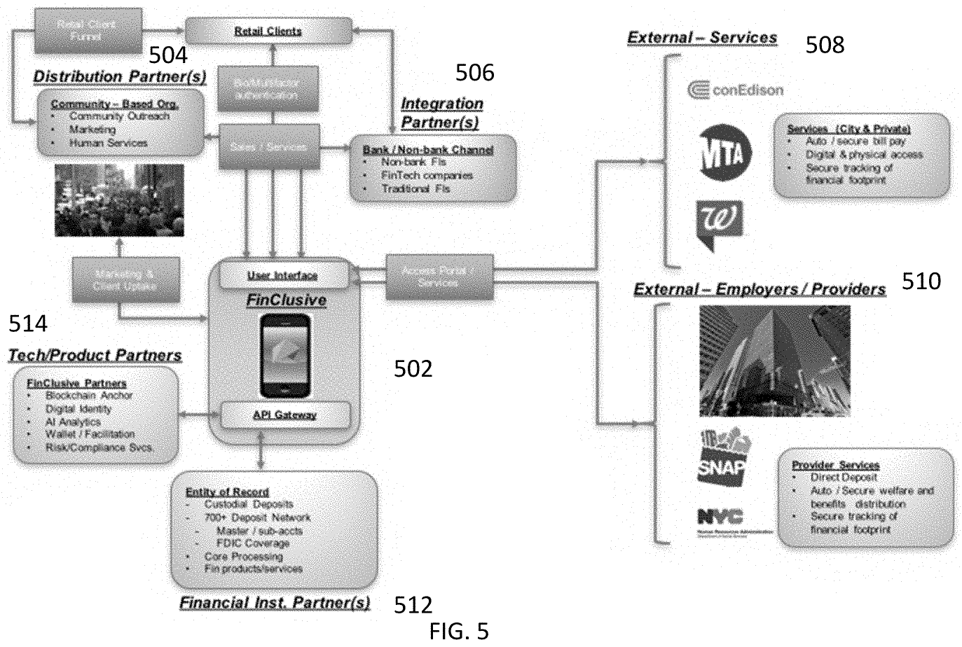

FIG. 5 illustrates an exemplary architecture of partner/client connectivity. As shown in FIG. 5, a central API gateway 502 is shown. The API Gateway 502 may be communicatively coupled to a multitude of distribution partners 504 that may provide community outreach, marketing, and human services. The partners 504 may be in contact with retail clients and in turn connected to integration partners 506. Integration partners may include bank and non-bank entities. Through an access portal, the API Gateway 502 may be connected to External Services 508 and External Employers/Providers 510. External Services 508 may provide services (city & private) including, for example, auto/secure bill pay, digital and physical access, and secure tracking of an entity's financial footprint. External Employers/Providers 510 may provide services such as direct deposit, auto/secure welfare benefits distribution, and secure tracking of financial footprint. API Gateway 502 may also be coupled Financial Institution Partners 512. Financial Institution Partners 512 may provide an entity of record. Services may include Custodial deposits, a 700+ deposit network including master/sub-accounts and FDIC coverage, core processing, and financial products and services, for example. API Gateway 502 may also be connected to Tech Product Partners 514. Partners 514 may provide a blockchain anchor, digital identity services, Artificial Intelligence analytics, digital wallet facilitation, and risk/compliance services, for example.

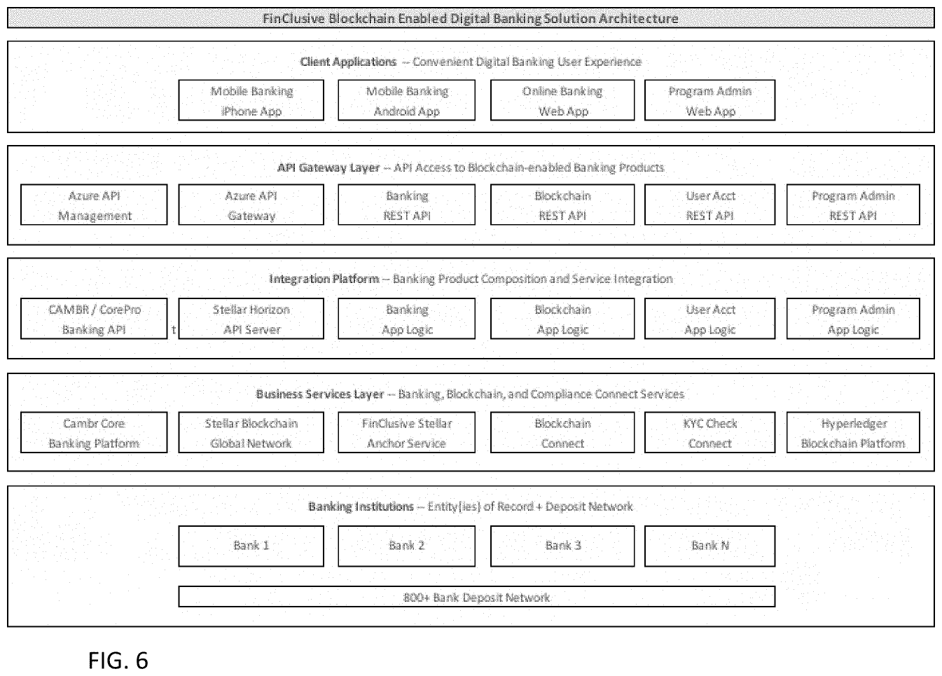

FIG. 6 illustrates a blockchain enabled digital banking solution architecture. The exemplary architecture may include a plurality of client applications. The client applications may include mobile and online banking applications and a program administration application, for example. Multiple layers may be utilized, such as an API Gateway Layer, an Integration Platform Layer, and a Business Services Layer. Finally, the architecture may include a plurality of banking institutions. The API Gateway Layer may be utilized to provide API access to blockchain-enabled banking products. The Gateway layer may include Azure API Management, Azure API Gateway, Banking REST API, Blockchain REST API, User Account REST API, and Program Admin REST API, for example. The Integration Platform is intended to provide banking product composition and service integration. The Integration Platform may include a CAMBR/CorePro Banking API, a Stellar Horizon API Server, Banking App Logic, Blockchain App Logic, User Account App Logic, and Program Admin App Logic, for example. The Business Services Layer is intended to provide banking, blockchain, and compliance connect services. The Business Services Layer may include a Cambr Core Banking Platform, a Stellar Blockchain Global Network, an Anchor Service, Blockchain Connect, KYC Check Connect, and a Hyperledger Blockchain Platform, for example. The Banking Institutions is intended to provide entities of record and a deposit network and may include a bank deposit network (800+ bank deposit network).

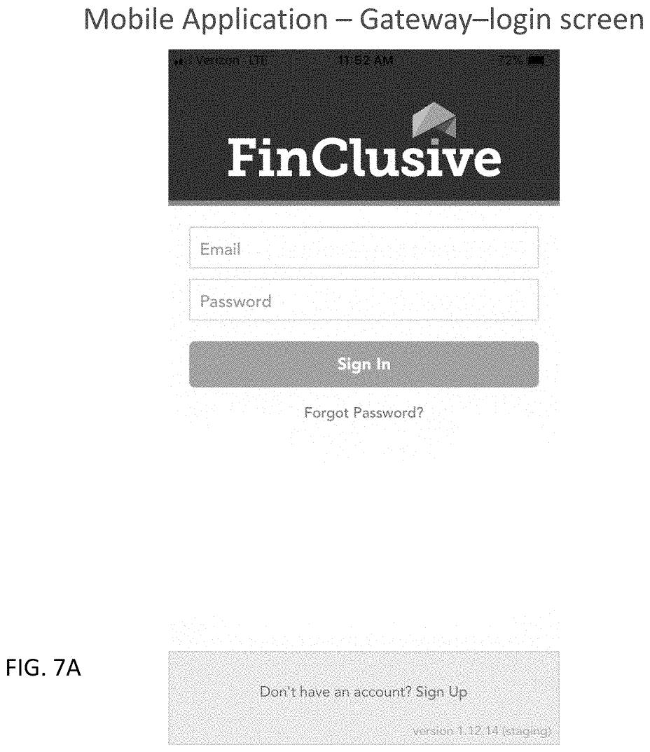

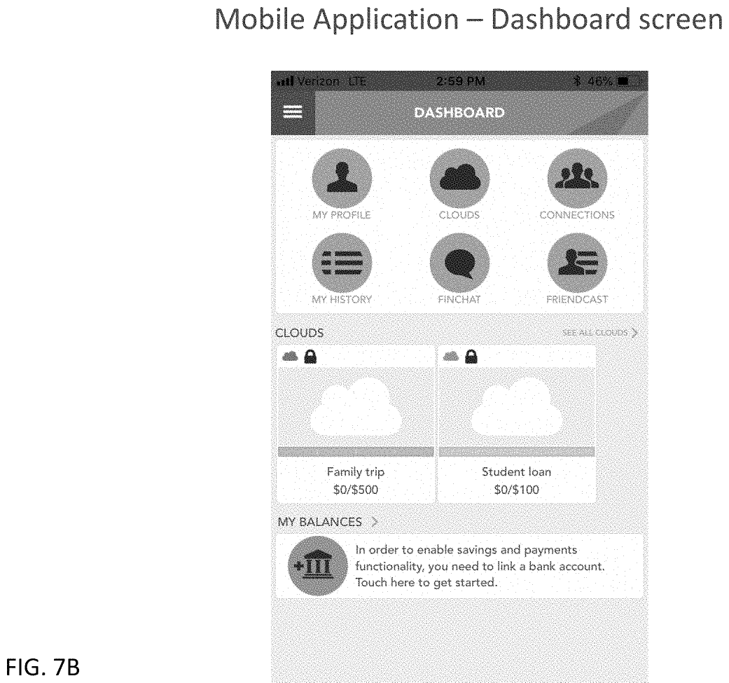

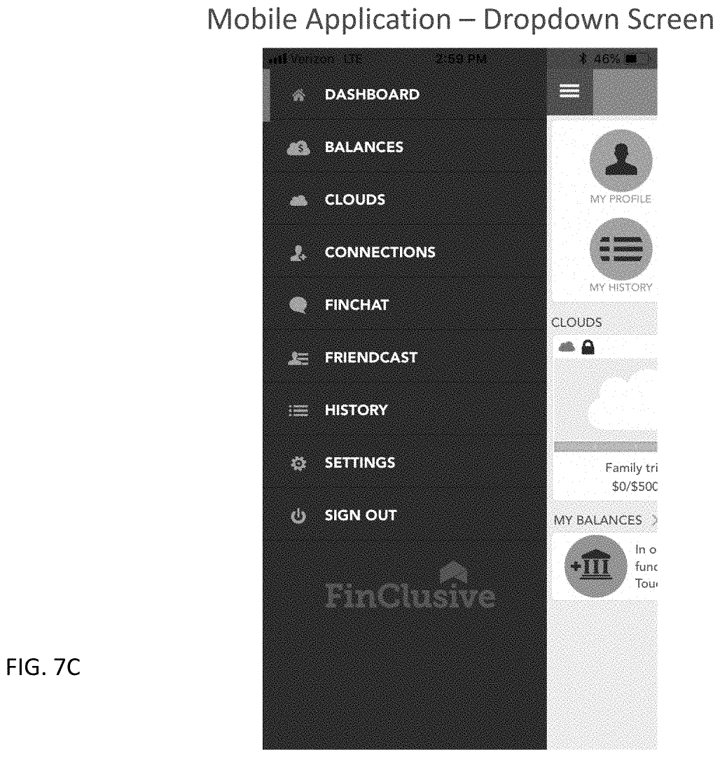

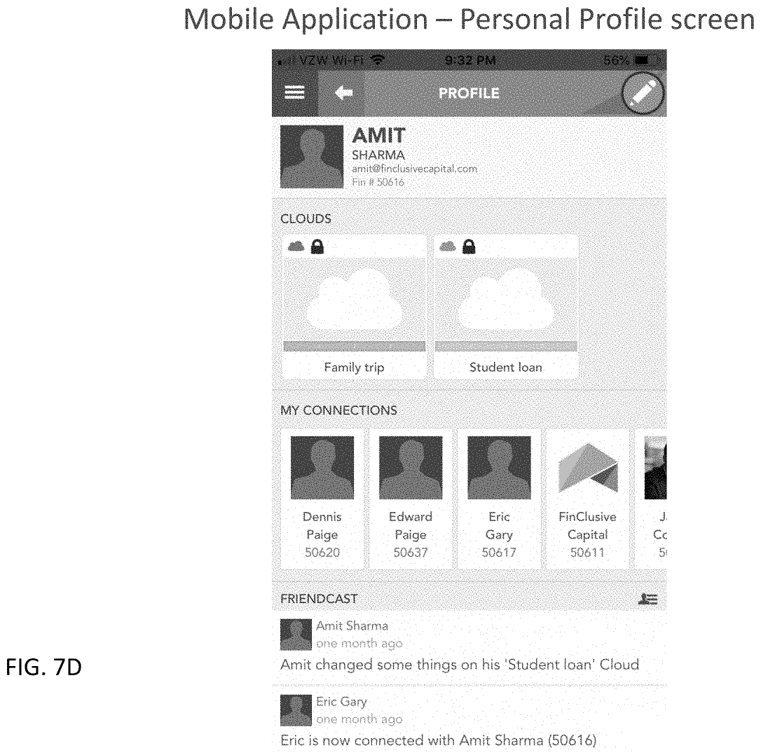

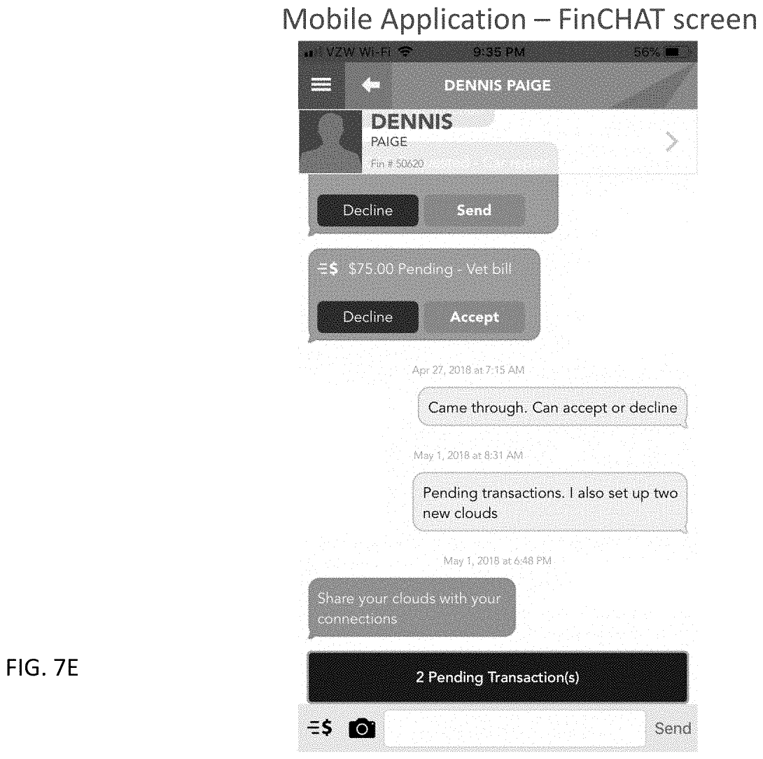

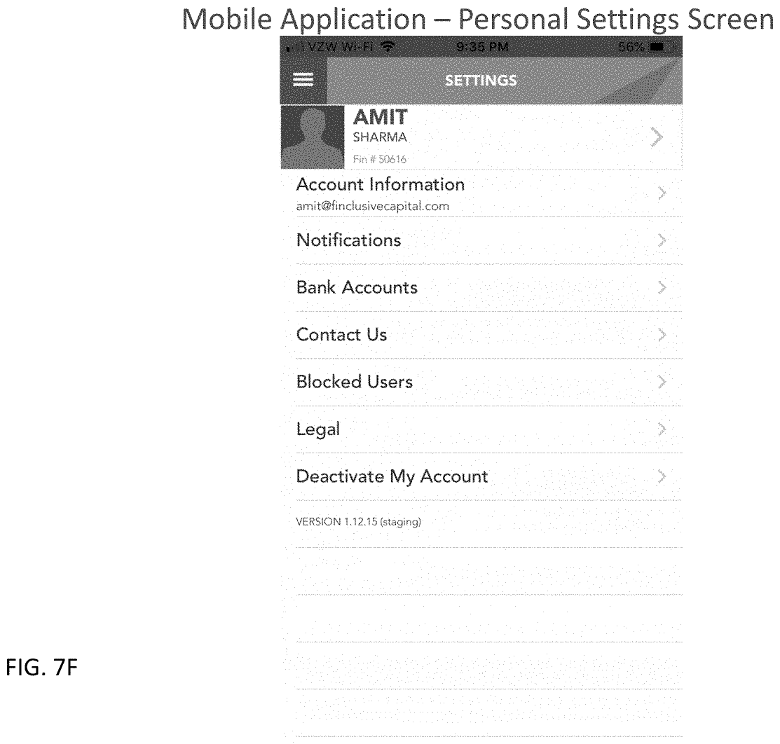

FIGS. 7A-7F illustrate exemplary screenshots of the disclosed invention with respect to mobile application implementation. FIG. 7A illustrates a gateway login screen. A user may be given the option to provide user credentials (e.g., username and password), an option to retrieve forgotten credentials (e.g., Forgot password?), and an option to create a new account (e.g., Sign Up). FIG. 7B illustrates a dashboard screen once a user is authenticated. A dashboard may include one or more icons (e.g., my profile, clouds, connections, my history, chat, and friendcast). Created clouds may be shown to the user of the device. Further, a user may be shown current balances.

As shown in FIG. 7C, a user may access a dropdown menu with further options. Options may include, but is certainly not limited to, balances, clouds, connections, chat, friendcast, history, settings, and a sign out option. FIG. 7D illustrates an exemplary personal profile screen. The profile screen may include, but is not limited to, personal details, clouds the user is connected to or a part of, user connections, and friendcast. FIG. 7E illustrates an exemplary chat session between two or more users. Users may initiate financial transactions, send messages, and initialize new or maintain clouds. FIG. 7F illustrates an exemplary personal settings screen. User settings may include, but are not limited to, account information, notifications, bank accounts, contact us, blocked users, legal, and the option to deactivate account. Different implementations may include alternate settings. Further, different level users (e.g., admin, power user) may be provided with different options.

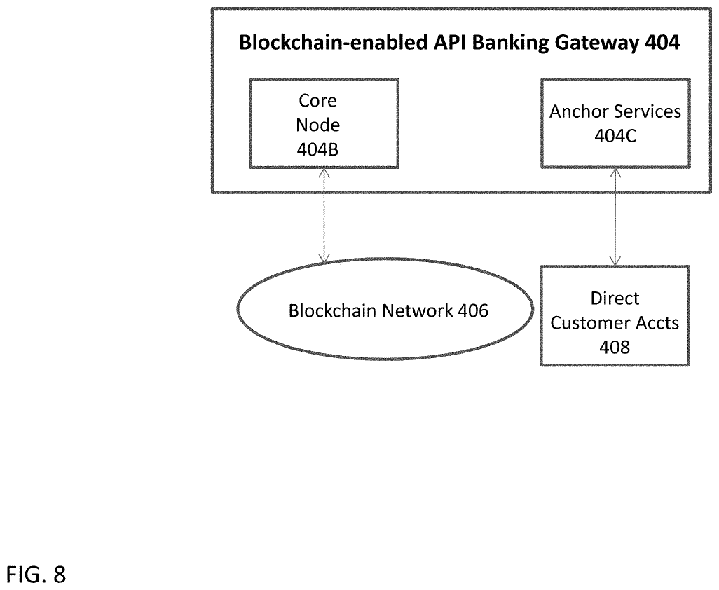

FIG. 8 illustrates the Blockchain-enabled API Banking Gateway 404 comprising a Core Node 404B and Anchor Services node 404C. Core Node 404B may be a node gateway engine and communicatively coupled to an external network, such as a blockchain network 406. Anchor services may be communicatively coupled to external user data, such as direct customer accounts database 408.

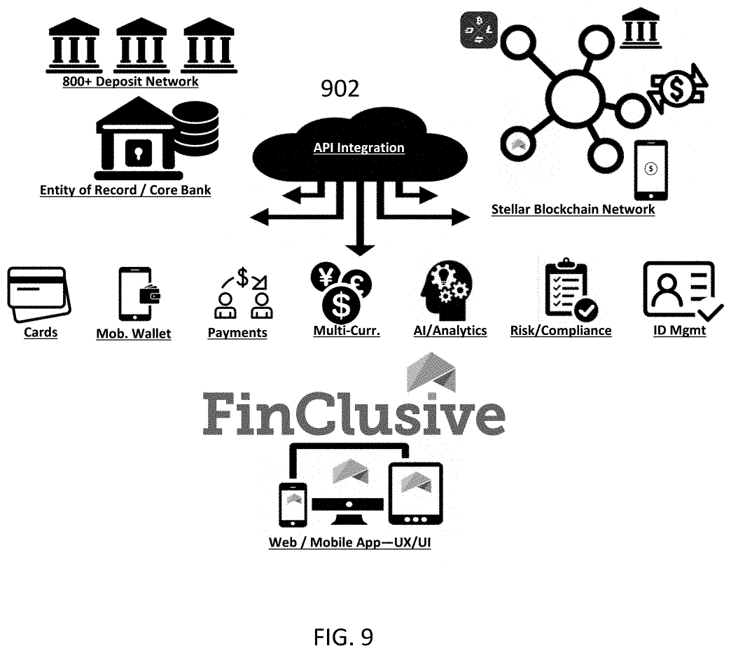

FIG. 9 illustrates a blockchain enabled digital banking solution architecture in accordance with one or more embodiments of the disclosed invention. FIG. 9 provides API integration server 902. The API Integration server may be a centralized server and is intended to provided integration services between multiple servers working concurrently to provide financial technology transactions. API 902 may provide integration between an Entity of Record/Core Bank that serves as a gateway to an 800+ Deposit Network, a Blockchain network, multiple payment services (e.g., credit cards, mobile wallet, payments, multi-currency, AI/Analytics, Risk/Compliance, and ID management), and finally, a web/mobile application user interface.

Digital Banking as a Service Platform

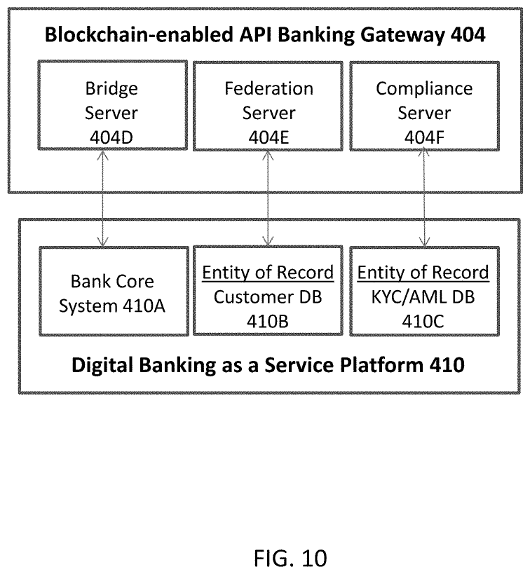

FIG. 10 illustrates, in a closeup view of FIG. 4, the blockchain-enabled API banking gateway 404 communicatively coupled with the digital banking as a service platform 410. The architecture may include a plurality of elements/components/modules working concurrently and in conjunction with each other. Banking gateway 404 may include a bridge server 404D, a federation server 404E, and a compliance server 404F, for example. Gateway 404 may be communicatively coupled with an external platform, such as Digital Banking as a Service Platform 410. Platform 410 may include a Bank Core system 410A, an Entity of Record Customer database 410B, and an Entity of Record KYC/AML database 410C.

The platform is designed with risk/compliance at its foundation

AML, KYC, and transaction analytics are essential beyond combatting financial crime—they are essential for security, efficiency and business intelligence

Phase 1—MVP

Global Standard-based protocols for essential AML activities—applied to both traditional and blockchain-based account access and engagements

KYC/CDD filters to enhance client onboarding

AI-enabled screening and due diligence for efficient client verification/authentication

Phase 2—MVP+ and Beyond

AI-enabled transaction analytics for both illicit finance protections and business intel

Real-time client and transaction monitoring

KYC-Check Connect via hyperledger to enhance clients' and partner bank/non-bank FIs' KYC/CDD and client verification needs real-time

Advanced Analytics overlay for enhanced transactions monitoring facilitating both illicit finance tracking and business intelligence

It is appreciated that exemplary computing system 100 is merely illustrative of a computing environment in which the herein described systems and methods may operate, and thus does not limit the implementation of the herein described systems and methods in computing environments having differing components and configurations. That is, the inventive concepts described herein may be implemented in various computing environments using various components and configurations.

Those of skill in the art will appreciate that the herein described apparatuses, engines, devices, systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the disclosure, any appended claims and any equivalents thereto.

In the foregoing detailed description, it may be that various features are grouped together in individual embodiments for the purpose of brevity in the disclosure. This method of disclosure is not to be interpreted as reflecting an intention that any subsequently claimed embodiments require more features than are expressly recited.

Further, the descriptions of the disclosure are provided to enable any person skilled in the art to make or use the disclosed embodiments. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but rather is to be accorded the widest scope consistent with the principles and novel features disclosed herein.

1. A system for the integration of core banking with blockchain functionality, the system comprising:
at least one processor;
at least one memory communicatively coupled to the at least one processor;
at least one module comprising one or more client applications;
a blockchain-enabled gateway;
a blockchain network; and
at least one service platform.

2. The system of claim 1, wherein the one or more client applications include at least one of:
mobile or text-based payment module,
mobile banking application, or
an online banking web application.

3. The system of claim 1, wherein the blockchain-enabled gateway comprises:
a horizon server,
a core node, and
one or more anchor services.

4. The system of claim 3, wherein the blockchain-enabled gateway further comprises:
a bridge server,
a federation server, and
a compliance server.

5. The system of claim 4, wherein the core node is communicatively coupled to the blockchain network.

6. The system of claim 3, wherein the one or more anchor services are communicatively coupled to a direct customer accounts database.

7. The system of claim 1, further comprising a digital banking as a service platform, the platform comprising:
a bank core system,
an entity of record customer database, and
an entity of record KYC/AML database.

8. The system of claim 5, wherein the blockchain network is the Stellar blockchain network.

9. The system of claim 3, wherein the one or more anchor services provides risk/compliance and ID management processes.

10. The system of claim 1, wherein the one or more client applications are provided to at least one user via an user interface on an external display.

11. A blockchain-enabled API banking gateway, comprising:
a core node; and
one or more anchor services.

12. The gateway of claim 11, wherein the core node is communicatively coupled to a blockchain network.

13. The gateway of claim 11, wherein the one or more anchor services are communicatively coupled to a direct customer accounts database.

14. The gateway of claim 13, wherein the direct customer accounts database is an external database.

15. The blockchain-enabled API banking gateway of claim 11, wherein the one or more anchor services provides risk/compliance and ID management processes.

16. An API integration server configured to:
provide integration services between multiple servers, the multiple servers configured to provide financial transactions; and
provide integration services between at least one gateway and one or more networks.

17. The API integration server of claim 16, wherein the API integration server is a centralized server.

18. The API integration server of claim 16, wherein the financial transactions are financial technology transactions.

19. The API integration server of claim 16, wherein the one or more networks includes one or more of a deposit network, a blockchain network, and a payment services network.

20. The API integration server of claim 19, wherein access to the one or more networks is provided via a user interface on an external display.
